(19) United States
(12) Patent Application Publication
(10) Pub. No.: US 2015/0260247 A1
(43) Pub. Date: Sep. 17, 2015

(54) BRAKING SYSTEM

(71) Applicant: Caterpillar Inc., Peoria, IL (US)

(72) Inventor: Brian D. Horton, Wilmette, IL (US)

(73) Assignee: Caterpillar Inc., Peoria, IL (US)

(21) Appl. No.: 14/203,597

(22) Filed: Mar. 11, 2014

(51) Int. Cl. F16D 65/72; B60T 13/14; B60T 13/68; B60T 13/66

(52) U.S. Cl. CPC F16D 65/72; B60T 13/662; B60T 13/14; B60T 13/686

(57) ABSTRACT

A braking system includes a brake charge module, an accumulator, and a pressure sensor coupled to the accumulator. The braking system further includes a brake actuator to selectively actuate a brake member based on a fluid pressure inside the brake actuator. The braking system further includes a brake valve disposed between the brake actuator and the accumulator. The brake valve is configured to regulate a flow of the pressurized fluid between the accumulator and the brake actuator. The braking system further includes a controller coupled to the pressure sensor and the brake valve. The controller is configured to determine a low-energy state of the accumulator based on the signal from the pressure sensor and maintain at least a pre-determined threshold value of fluid pressure within the brake actuator to retain the brake member at a touch up position with respect to a rotating member.

### TECHNICAL FIELD

The present disclosure relates to a braking system, and more particularly to a braking system for retaining a brake member at a touch up position with respect to a rotating member.

### BACKGROUND

Manufacturers of braking systems are continuously developing various structures and modes of braking operations for implementation into machines. For example, U.S. Pat. No. 6,945,610 discloses a hydraulically operated braking system that includes a master cylinder having a pressurizing piston operatively connected to a brake-operating member. The master cylinder pressurizes a fluid in a pressurizing chamber so that a brake cylinder is actuated by the pressurized fluid. The braking system further includes an assisting device for applying an assisting drive force to the pressurizing piston. This assisting drive force is different from a primary drive force and is to be applied to the pressurizing piston based on a brake operating force acting on the brake operating member. The assisting device is electrically controllable to control the assisting drive force.

Moreover, ever-increasing stringent regulations are driving manufacturers to adopt more and more robust braking strategies in the event of an abnormality in the machine. Accordingly, in some cases, braking systems may be configured with appropriate functionality to execute braking of the machine during emergency conditions. However, in an event of abnormality in the machine, accumulators of such braking systems may have a finite capacity for operatively delivering the required volume of pressurized fluid and effect the braking of a rotating member. For example, in some cases, the accumulators may be depleted of fluid during an emergency condition and hence, actual use of the fluid may not be possible for reducing a speed of the rotating member during such emergency condition.

### SUMMARY

In one aspect, the present disclosure provides a braking system including a brake charge module, an accumulator, a pressure sensor, a brake actuator, a brake valve, and a controller. The brake charge module is configured to supply a pressurized fluid. The accumulator is configured to store the pressurized fluid therein. The pressure sensor is coupled to the accumulator and configured to generate a signal corresponding to a fluid pressure within the accumulator. The brake actuator is configured to receive the pressurized fluid from the accumulator and selectively actuate a brake member therein based on a fluid pressure inside the brake actuator. The brake valve is disposed between the brake actuator and the accumulator. The brake valve is configured to regulate a flow of the pressurized fluid between the accumulator and the brake actuator. The controller is communicably coupled to at least the pressure sensor and the brake valve. The controller is configured to determine a low-energy state of the accumulator based on at least the signal from the pressure sensor. The controller is further configured to maintain the fluid pressure within the brake actuator above a pre-determined threshold value to retain the brake member at a touch up position with respect to a rotating member.

In another aspect, the present disclosure provides a machine including at least one rotating member, and a braking system operatively coupled to the at least one rotating member. The braking system includes a brake charge module, an accumulator, a pressure sensor, a brake actuator, a brake valve, and a controller. The brake charge module is configured to supply a pressurized fluid. The accumulator is configured to store the pressurized fluid therein. The pressure sensor is coupled to the accumulator and configured to generate a signal corresponding to a fluid pressure within the accumulator. The brake actuator is configured to receive the pressurized fluid from the accumulator and selectively actuate a brake member therein based on a fluid pressure inside the brake actuator. The brake valve is disposed between the brake actuator and the accumulator. The brake valve is configured to regulate a flow of the pressurized fluid between the accumulator and the brake actuator. The controller is communicably coupled to at least the pressure sensor and the brake valve. The controller is configured to determine a low-energy state of the accumulator based on at least the signal from the pressure sensor. The controller is further configured to maintain the fluid pressure within the brake actuator above a pre-determined threshold value to retain the brake member at a touch up position with respect to a rotating member.

In another aspect, the present disclosure provides a method of controlling a braking system. The method includes determining, by a controller, low-energy state of an accumulator of the braking system based on at least a fluid pressure within the accumulator. The method further includes maintaining a fluid pressure of a brake actuator above a pre-determined threshold value such that a brake member therein is maintained in a touch-up position with respect to a rotating member.

Other features and aspects of this disclosure will be apparent from the following description and the accompanying drawings.

### BRIEF DESCRIPTION OF THE DRAWINGS

FIG. 1 is a perspective view of an underside of an exemplary machine embodied as a vehicle;

FIG. 2 is a diagrammatic representation of a braking system employed by the exemplary machine in which a rotating member of the braking system is shown in a freewheeling state;

FIG. 3 is a diagrammatic representation of a braking system employed by the exemplary machine in which the braking system is shown in a touch up position with the rotating member in accordance with another embodiment of the present disclosure;

FIG. 4 is a schematic representation of the braking system in accordance with an embodiment of the present disclosure; and

FIG. 5 is a method of controlling the braking system.

### DETAILED DESCRIPTION

The present disclosure relates to a braking system for retaining a brake member at a touch up position with respect to a rotating member. Wherever possible the same reference numbers will be used throughout the drawings to refer to same or like parts. Moreover, references to various elements described herein, are made collectively or individually when there may be more than one element of the same type. However, such references are rendered to merely aid the reader's understanding of the present disclosure and hence, to be considered exemplary in nature. Accordingly, it may be noted that any such reference to elements in the singular is also to be construed to relate to the plural and vice versa without limiting the scope of the disclosure to the exact number or type of such elements unless set forth explicitly in the appended claims.

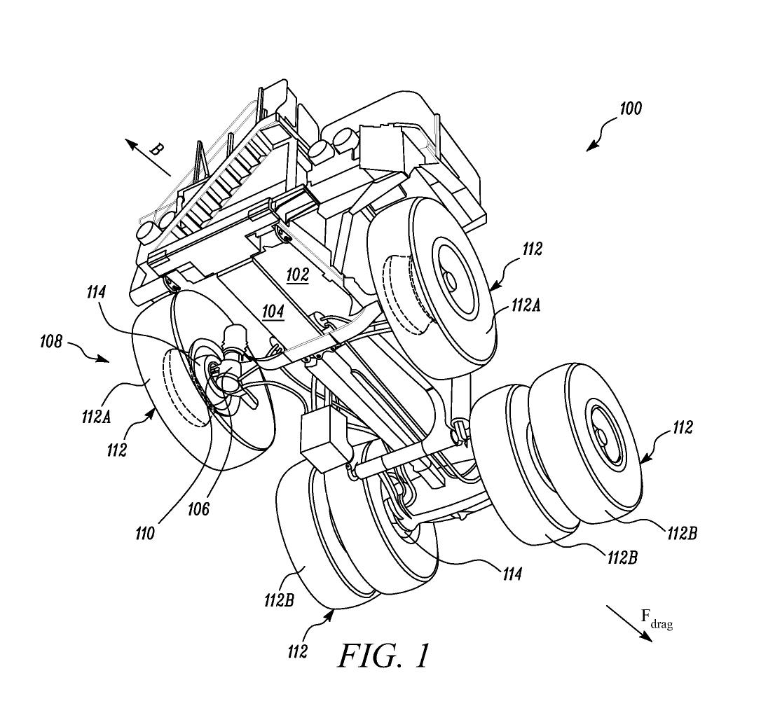

FIG. 1 shows a perspective view of an underside of an exemplary machine 100. As illustrated in FIG. 1, the machine 100 is embodied as a vehicle, for example, a mining truck. The mining truck may be employed for hauling earth materials such as soil, debris, or other naturally occurring deposits from a worksite. Although a mining truck is depicted in FIG. 1, other types of mobile machines such as, but not limited to, motor graders, bulldozers, articulated trucks, on-highway trucks, tractor-scrapers, tractors in combination with trailers, or the like may be employed in lieu of the mining truck.

The machine 100 includes a prime mover 102, a frame 104, multiple struts 106 and multiple wheel assemblies 108. The prime mover 102 is mounted on the frame 104. The prime mover 102 may be a fuel-based engine to power the machine 100 by combustion of natural resources, such as gasoline, liquid natural gas, or other petroleum products. Moreover, the engine may be a petrol engine, diesel engine, or any other kind of engine utilizing combustion of fuel for generation of power. However, in an alternative embodiment, the present disclosure may be equally implemented by way of using an electric motor in place of the engine as the prime mover 102. Therefore, any type of prime mover commonly known in the art may be employed without deviating from the spirit of the present disclosure.

Each of the wheel assemblies 108 includes a spindle 110, and a wheel 112. The wheel 112 is rotatably supported on the spindle 110. The spindle 110 is connected to the strut 106 which in turn, is connected to the frame 104. Therefore, the strut 106 connects the spindle 110 of the wheel assembly 108 to the frame 104. The connection of the wheel assembly 108 to the frame 104 by the strut 106 is analogous to a spring-mass damper system. The strut 106 is configured to absorb any shocks and vibrations from the wheel 112 during operation of the machine 100. Further, the strut 106 is configured to prevent transfer of such shocks and vibrations to the frame 104. A person having ordinary skill in the art will acknowledge that the strut 106 may be of a hydraulic type or a pneumatic type.

The wheels 112 disclosed herein may refer to idle wheels 112a or powered wheels 112b as shown in FIG. 1. The idle wheels 112a are used for steering and subsequently controlling of the machine 100. However, the powered wheels 112b are connected to the prime mover 102 and hence, powered directly by the prime mover 102. Therefore, movement of the powered wheels 112b may cause the idle wheels 112a to rotate relative to the frame 104 and propel the machine 100 on a ground surface.

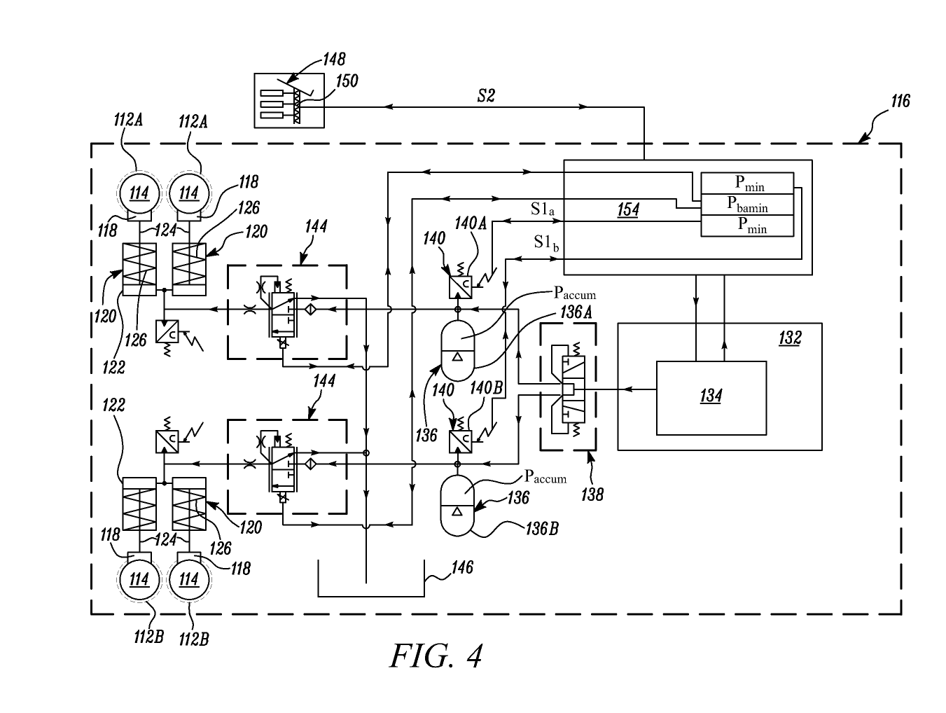

In an aspect of the present disclosure, the machine 100 disclosed herein, may be an autonomous machine, or an operator-driven machine. It is to be noted that structures, methods, and systems of the present disclosure can be equally applied to various types of machines without deviating from the spirit of the present disclosure. If the machine 100 is autonomous, a control system (not shown) may be remotely located and disposed in wireless connection with the autonomous machine 100. The control system may then remotely and/or wirelessly control a steering system, a braking system 116 (as shown in FIG. 4), or any other system of the machine 100 and accomplish control over the machine 100 without the need for an operator. However, if the machine 100 is operator-driven, the operator may manually control the various systems of the machine 100 and execute operations and/or perform functions associated with the machine 100.

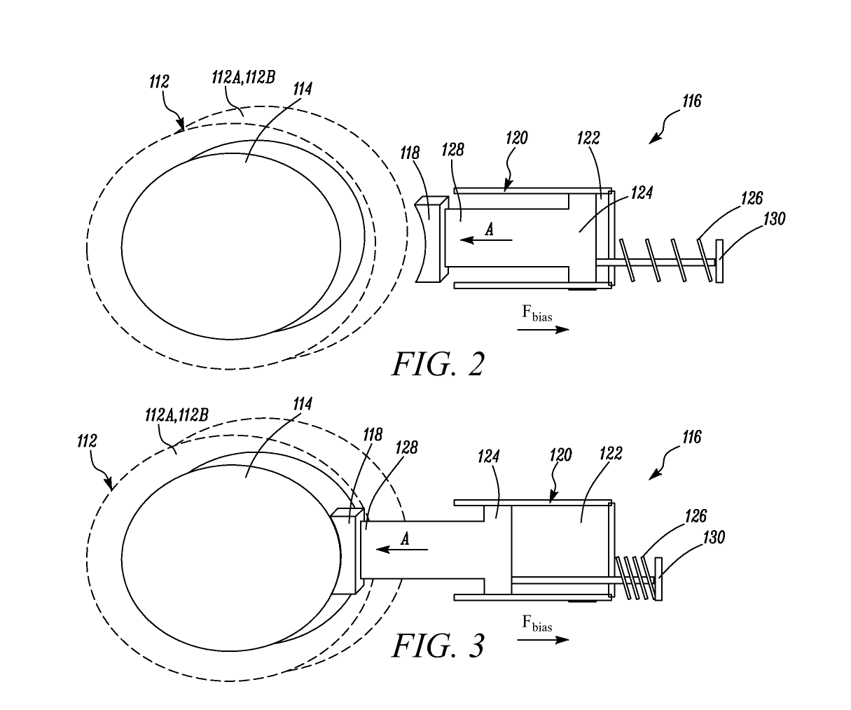

Referring to FIGS. 1-3, the machine 100 includes at least one rotating member 114 coupled to the idle wheel 112a or the powered wheel 112b. The rotating member 114 may be a brake drum. Optionally, a brake disc may be used in place of the brake drum depicted in FIGS. 1-3. The machine 100 further includes the braking system 116 of the present disclosure as depicted in FIG. 4. Referring to FIG. 2, the braking system 116 is operatively coupled to the rotating member 114. The braking system 116 includes a brake member 118. The brake member 118 may be, for example, a brake shoe corresponding to the drum-type rotating member 114 depicted in FIGS. 2 and 3. The brake shoe has a frictional contact surface that is disposed towards the rotating member 114 and during rotation of the rotating member 114; the brake member 118 may reduce a rotational speed of the rotating member 114 when brought in contact with the rotating member 114.

Although, the brake member 118 is disclosed as the brake shoe herein, a person having ordinary skill in the art will acknowledge that the brake shoe is merely exemplary in nature and hence, non-limiting of this disclosure. Any suitable type of brake member known in the art may be selected for implementation with the present disclosure. For example, if the braking system 116 is of a disc type, then a brake pad may be used in lieu of the brake shoe as the brake member 118. In another example, the braking system 116 can be of a wet brake type, or a dry brake type as commonly known in the art. Therefore, the type of brake member used may depend on the type of braking system 116, for example, a wet brake system, dry brake system, a disc brake system, or a drum brake system, or other specific requirements of an braking application and correspondingly be implemented for use with the disclosed embodiments without deviating from the scope of the present disclosure.

Further, as shown in FIGS. 2-3, the braking system 116 includes a brake actuator 120 associated with the braking member. The brake actuator 120 is configured to selectively actuate the brake member 118 based on a fluid pressure therein. The brake actuator 120 may include components such as a brake cylinder 122, a brake piston 124, and a biasing member 126. Although the brake cylinder 122, the brake piston 124, and the biasing member 126 are disclosed herein, it is to be noted that the components of the brake actuator 120 are not limited thereto; rather, the brake actuator 120 may include other suitable structures and components known in the art to execute the functions of selectively actuating the brake member 118.

In the specific embodiment as shown in FIGS. 2 and 3, the brake piston 124 is disposed within the brake cylinder 122 and coupled to the brake member 118 (the brake member 118 is shown connected to an end 128 of the brake piston 124). The biasing member 126 (shown coupled to the other end 130 of the brake piston 124) is configured to bias the brake piston 124 and the brake member 118 away from the rotating member 114. The biasing member 126 may be, for example, a compression spring, or a tension spring, but is not limited thereto. Other suitable structures may be employed in lieu of the compression spring or the tension spring disclosed herein.

If the fluid pressure in the brake cylinder 122 is insufficient to overcome the compressive force F_{bias} of the biasing member 126, then the brake member 118 may be disposed in a retracted state as shown specifically in FIG. 2. In this configuration, the rotating member 114 may be free to execute rotations associated with rotation of the wheels 112a or 112b.

However, referring to FIG. 3, if the fluid pressure in the brake cylinder 122 overcomes a pre-determined threshold value Pbaₘᵢₙ corresponding to the compressive force F_{bias} of the biasing member 126, then the brake piston 124 may be pushed forward (in direction A) and allow the brake member 118 to be disposed in contact with the rotating member 114. It is to be noted that the exemplary illustration of FIG. 3 shows the brake member 118 in contact with the rotating member 114 without substantial braking force. Hence, any further increase in fluid pressure within the brake cylinder 122 may cause an increase in the braking force of the brake member 118 on the rotating member 114. For purposes of clarity in understanding the present disclosure, explanation pertaining to the contact position of the brake member 118 with respect to the rotating member 114 hereinafter, will be made as a “touch up position”.

Although it is disclosed herein that the touch up position is to be regarded as the position in which the brake member 118 merely makes contact with the rotating member 114 without substantial braking force thereon, a person having ordinary skill in the art will acknowledge that an amount of the braking force in the touch up position may vary from application to application. For large and/or heavy rotating members, more braking force may be beneficially implemented in the touch up position while for small and light rotating members; the braking force on the rotating member 114 in the touch up position may be kept small. However, with reference to the embodiments disclosed herein, it is to be noted that the braking force realized on the rotating member 114 in the touch up position is substantially less than the maximum braking force of the braking system 116. For example, the touch up position may be implemented as a braking force that is 10% of the maximum braking force. In another example, the touch up position may be implemented as a braking force that is 15% of the maximum braking force. In yet another example, the braking force in the touch up position may be 5% of the maximum braking force.

As shown in a schematic representation of the braking system 116 in FIG. 4, the braking system 116 includes a brake charge module 132 configured to supply a pressurized fluid. In an embodiment as shown in FIG. 4, the brake charge module 132 may include a pump 134 therein. The pump 134 is configured to pressurize the fluid. The braking system 116 further includes an accumulator 136 (two accumulators 136a, and 136b shown, one each for the idle wheels 112a and the powered wheels 112b). The accumulator 136 is fluidly coupled to the brake charge module 132.

In the specific embodiment of FIG. 4, the two accumulators 136a and 136b are disposed in selective fluid communication with the pump 134 via a control valve 138. As shown, the control valve 138 is disposed between the brake charge module 132 and the accumulators 136a and 136b. The control valve 138 may be, for example, a spool valve (as shown). The control valve 138 may regulate a flow of the pressurized fluid from the brake charge module 132 to the respective accumulators 136a and 136b. During operation, the accumulator 136 receives the pressurized fluid from the pump 134 of the brake charge module 132. The accumulator 136 stores the pressurized fluid therein. The control valve 138 may additionally maintain a balance of fluid pressures P_{accum} in the two accumulators 136a and 136b. If the fluid pressure P_{accum} in one of the accumulators 136a or 136b falls below that of the other accumulator 136a or 136b, the spool valve may be actuated, hydraulically or electronically, into a pre-defined position such that the pressurized fluid from the pump 134 is routed to the accumulator 136a or 136b with the lower fluid pressure. Although a spool valve is disclosed herein, it is to be noted that the spool valve is merely exemplary in nature, and hence, non-limiting of this disclosure. Any type of valve commonly known in the art may be used in place of the spool valve to maintain desired fluid pressures P_{accum} in the respective accumulators 136a or 136b. Some examples of such valves may include, but are not limited to, check valves, ball valves, butterfly valves, needle valves, solenoid valves and the like. Moreover, in place of a single spool valve, any number of the known types of valves may be used. For example, one check valve may be associated with each accumulator 136a and 136b and replace the single spool valve configuration depicted in FIG. 4.

The braking system 116 further includes a pressure sensor 140 coupled to the accumulator 136 (Two pressure sensors 140a and 140b are shown in the schematic representation of FIG. 4, one pressure sensor 140 for each accumulator 136). The pressure sensors 140a and 140b are configured to generate signals S1ₐ and S1_{b} corresponding to a fluid pressure P_{accum} within the associated accumulators 136a and 136b. Further, the brake actuator 120 is disposed in selective fluid communication with the accumulator 136. The brake actuator 120 is configured to receive the pressurized fluid from the accumulator 136 and selectively actuate the brake member 118 therein based on the fluid pressure inside the brake actuator 120.

The braking system 116 further includes a brake valve 144 disposed between the brake actuator 120 and the accumulator 136. In the specific embodiment as shown in FIG. 4, the brake valve 144 is a solenoid-actuated valve. The brake valve 144 renders the accumulator 136 in selective fluid communication with the brake actuator 120. Accordingly, the brake valve 144 is configured to regulate a flow of the pressurized fluid between the accumulator 136 and the brake actuator 120. Additionally, the brake valve 144 renders the brake actuator 120 in selective fluid communication with a fluid sump 146 of the braking system 116.

The braking system 116 further includes a control module 148, and an actuation sensor 150 associated thereto. The control module 148 is operable by a user from a non-actuated configuration. The control module 148 may be any implement such as, but not limited to, a brake lever (as shown schematically in FIG. 4), a brake switch or may be formed by other structures commonly known in the art. Hence, a person having ordinary skill in the art may acknowledge that the brake lever depicted in FIG. 4 is merely exemplary in nature and hence, non-limiting of this disclosure. Other types of control modules known in the art may be applied in lieu of the brake lever for implementation of the present disclosure.

For ease in understanding of the present disclosure, the terms “non-actuated configuration” is used to refer to a position of the brake lever when the foot of the operator is not on the brake lever. Similarly, if the control module 148 is a brake switch, the terms “non-actuated configuration” may imply that the switch is in the “OFF” state. Such brake lever or brake switch may be operated by the user and positioned, re-positioned, or actuated from the non-actuated configuration into a state of operation. It may be evident to a person having ordinary skill in the art that the terms “non-actuated configuration” is intended to describe a non-operative state of the control module 148. Therefore, the terms “non-actuated configuration” as used in the present disclosure serve to merely aid the reader's understanding of the present disclosure, and must be nominally construed without creating limitations to the present disclosure.

As shown in FIG. 4, the actuation sensor 150 is associated with the control module 148. The actuation sensor 150 is configured to generate a signal S2 corresponding to an actuation of the control module 148. Optionally, the signal S2 from the actuation sensor 150 may be additionally indicative of a magnitude of actuation of the control implement. For example, the actuation sensor 150 may generate the signal S2 to indicate that the brake lever has been depressed. In addition, the actuation sensor 150 may further indicate, via the same signal S2 or another signal, that the brake lever has been depressed to, for example, 30% of the way, i.e., to 30% of its total length of travel, or to 50% of the way, i.e., to 50% of its total length of travel.

In one embodiment, the actuation sensor 150, disclosed herein, may be coupled to the control module 148. In another embodiment, the actuation sensor 150 may be disposed proximal to the control module 148. It is to be noted that a type of association between the control module 148 and the actuation sensor 150 may depend on the type of actuation sensor 150. Depending on the specific type of actuation sensor used, the actuation sensor 150 may be suitably associated or coupled with the control module 148, for example, by mechanical, electrical, electro-mechanical, electronic, or any other means commonly known in the art. Some examples of sensors that can be used to form the actuation sensor 150 of the present disclosure may include, but are not limited to, position sensors, proximity sensors, hall-effect sensors, inductive non-contact type sensors, capacitive transducers, photo-diode arrays (PDAs) and the like. Therefore, any type of actuation sensor may be used for implementation of the present disclosure.

The braking system 116 further includes a controller 154 communicably coupled to at least the pressure sensor 140 and the brake valve 144. Additionally, the controller 154 may be communicably coupled to the actuation sensor 150. The controller 154 is configured to determine a low-energy state of the accumulator 136 based on at least the signal S1ₐ or S1_{b} from the pressure sensors 140. In one embodiment, the low-energy state of the braking system 116, disclosed herein, may correspond to the fluid pressure P_{accum} within the accumulator 136 falling below a pre-defined minimum value Pₘᵢₙ. The pre-defined minimum value Pₘᵢₙ, disclosed herein, may be determined beforehand and pre-set into the controller 154. The pre-defined minimum value Pₘᵢₙ may be obtained from test data, for example, pre-calculated tables, curves, graphs, and may be obtained from various theoretical models, statistical models, simulated models or any combinations thereof.

The controller 154 is further configured to maintain the fluid pressure within the brake actuator 120 above a pre-determined threshold value Pbaₘᵢₙ to retain the brake member 118 at the touch up position with respect to a rotating member 114. The pre-determined threshold value Pbaₘᵢₙ of the fluid pressure in the brake cylinder 122 is greater than a force F_{bias} of the biasing member 126. Explanation pertaining to a working of the braking system 116 will be made later in this document.

A person having ordinary skill in the art will appreciate that in various embodiments of the present disclosure, the controller 154 may be embodied in the form of an ECM (electronic control module) package and may be implemented for use with the machine 100. The ECM may include various associated system hardware and/or software components such as, for example, input/output (I/O) devices, analog-to-digital (A/D) converters, processors, micro-processors, chipsets, read-only memory (ROM), random-access memory (RAM), and secondary storage devices such as, but not limited to, diskettes, floppies, compact disks, or Universal Serial Bus (USB), but not limited thereto. Such associated system hardware may be configured with various logic gates and/or suitable programs, algorithms, routines, protocols in order to execute the functions of the controller 154 disclosed in the present disclosure.

### INDUSTRIAL APPLICABILITY

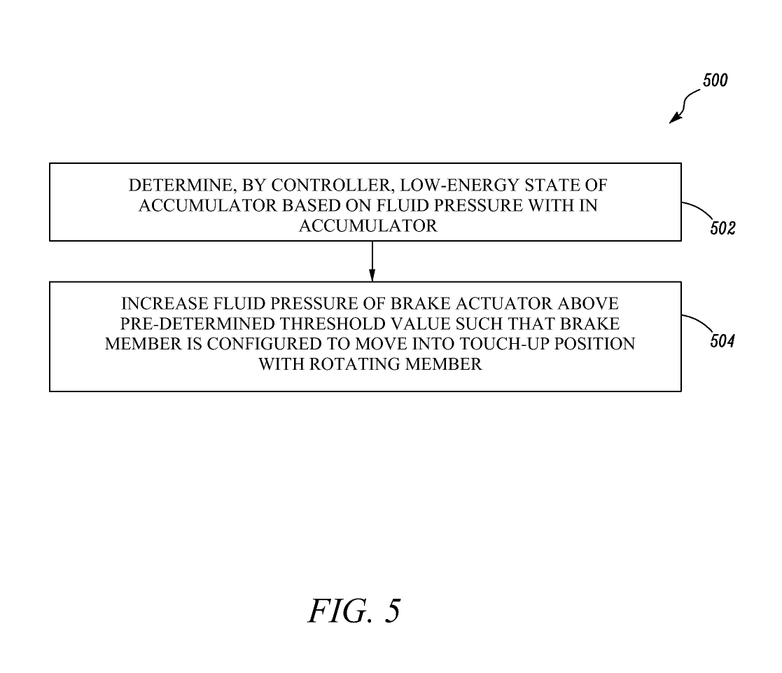

FIG. 5 shows a method 500 of controlling the braking system 116. At step 502, the method 500 includes determining, by the controller 154, low-energy state of the accumulator 136 of the braking system 116 based on at least the fluid pressure P_{accum} within the accumulator 136. In an embodiment, the low-energy state of the braking system 116 corresponds to the fluid pressure P_{accum} within the accumulator 136 falling below the pre-defined minimum value Pₘᵢₙ.

At step 504, the method 500 further includes maintaining the fluid pressure of the brake actuator 120 above the pre-determined threshold value Pbaₘᵢₙ such that the brake member 118 therein is maintained in the touch up position with respect to the rotating member 114. In an embodiment, the method 500 includes increasing the fluid pressure in the brake actuator 120 to a value above the pre-determined threshold value Pbaₘᵢₙ. Although it is disclosed in various embodiments of the present disclosure that the fluid pressure in the brake actuator 120 may be increased to a value greater than the pre-determined threshold value Pbaₘᵢₙ, it is to be understood that the converse is also true. Le., it may be understood that in order to implement the method 500 of the present disclosure, the fluid pressure in the brake actuator 120 can be prevented from falling below the pre-determined threshold value Pbaₘᵢₙ. Therefore, the word “maintain”, used in conjunction with the fluid pressure of the brake actuator 120, can be construed to include any one or both functions, namely—increasing the fluid pressure in the brake actuator 120, and preventing a drop in the fluid pressure of the brake actuator 120 below the pre-determined threshold value Pbaₘᵢₙ.

The method 500 may include biasing the brake member 118 away from the rotating member 114 with the force F_{bias} of the biasing member 126. However, in the event of an abnormality, the method 500 includes routing the pressurized fluid from the accumulator 136 to the brake actuator 120 such that the fluid pressure within the brake actuator 120 is maintained at a value above the pre-determined threshold value Pbaₘᵢₙ. As disclosed earlier herein, the pre-determined threshold value Pbaₘᵢₙ of fluid pressure in the brake actuator 120 is greater than the force F_{bias} of the biasing member 126.

During normal operation of the machine 100, i.e., when no abnormality occurs in any of the systems, for example, the engine (see FIG. 1), or the pump 134 of the machine 100 (See FIG. 4), then the brake charge module 132 may pressurize and supply an adequate volume and pressure of fluid to the accumulator 136. Accordingly, the accumulator 136 may also receive and store such pressurized volume of fluid within. Further, operation of the braking member may be implemented through the control module 148 and at the user's discretion. Hence, the braking force on the rotating member 114 and the associated wheel 112a or 112b may be controlled manually, i.e., by the user of the machine 100.

However, in the event of an abnormality of a system in the machine 100, for example, failure of the engine or a failure of the pump 134, but not limited thereto, the brake charge module 132 may pressurize little or no fluid for supply to the accumulator 136. Accordingly, a fluid pressure P_{accum} within the accumulator 136 may drop to a value below the pre-defined minimum value Pₘᵢₙ, thus rendering the accumulator 136 in a low charge or low-energy state. The associated pressure sensor 140 may detect such low-energy state of the accumulator 136, and upon detection of the low-energy state, generate signals S1ₐ or S1_{b} corresponding to the low-energy state. These generated signals S1ₐ and S1_{b} may be provided to the controller 154 upon which the controller 154 may maintain the fluid pressure within the brake actuator 120 above the pre-determined threshold value Pbaₘᵢₙ. Specifically, upon receiving the signals S1 (collectively refers to S1ₐ and S1_{b}) and S2, the controller 154 may trigger the respective brake valves 144 into a position that is configured to allow movement of the pressurized fluid from the accumulator 136 to the brake actuator 120 while simultaneously preventing egress of the pressurized fluid from the brake actuator 120 into the fluid sump 146 (See FIG. 4).

As the brake valve 144 allows pressurized fluid from the accumulator 136 to enter the brake actuator 120 while preventing any pressurized fluid from leaving the brake actuator 120 and entering the fluid sump 146, the fluid pressure in the brake actuator 120 can be increased quickly without loss of fluid from the brake actuator 120. Specifically, the fluid pressure in the brake cylinder 122 can be brought above the pre-determined threshold value Pbaₘᵢₙ to bring the brake member 118 in the touch up position with respect to the rotating member 114 (See FIGS. 3 and 4). Further, the controller 154 may continue to maintain the brake valve 144 in such position (i.e., corresponding to the brake member 118 in the touch up position) until the abnormality is rectified or removed.

By maintaining the fluid pressure above the pre-determined threshold value Pbaₘᵢₙ in the brake actuator 120, the touch up position may cause a small amount of braking force to be incident on the rotating member 114. Consequently, the machine 100 (as shown in FIG. 1) may experience some amount of brake drag F_{drag} (exemplarily shown as opposing the forward movement B of the machine 100) due to the braking force presented from the touch up position of the brake member 118.

The controller 154 may be additionally configured to determine an actuation and/or magnitude of actuation in the control module 148 based on the signal S2 from the actuation sensor 150. Based on such determination, the controller 154 may increase the fluid pressure within the brake actuator 120 and move the brake member 118 beyond the touch up position, i.e., into a braking position with respect to the rotating member 114. The braking position, disclosed herein, may be regarded as a position of the brake member 118 at which the braking force is larger than the braking force experienced by the rotating member 114 in the touch up position.

It is envisioned that once the brake member 118 is in the touch up position, very little pressurized fluid may be required from the accumulator 136 in order to move the brake member 118 into the braking position and accomplish the large braking force on the rotating member 114. Therefore, as shown in FIGS. 2 and 3, when the brake actuator 120 is filled with the pressurized fluid from the accumulator 136 to the pre-determined threshold value Pbaₘᵢₙ (i.e., the brake member 118 is already in the touch up position with the rotating member 114), any additional fluid from the accumulator 136 supplied thereafter to the brake actuator 120 can only be possible in small quantities. As such, the quantity or volume of such additionally supplied fluid is significantly less the volume of fluid initially sent to the brake actuator 120 for accomplishing the touch up position of the brake member 118. Hence, in the event of abnormality, the quantum of fluid required over and above the touch up position to engage the braking position can be very little. Therefore, with use of such little pressurized fluid, the brake member 118 can quickly move from the touch up position into the braking position and cause substantial or full braking force to be effected on the rotating member 114.

As disclosed earlier herein, when the accumulator 136 contains less pressurized fluid therein (i.e., fluid pressure P_{accum} is less than the pre-defined minimum fluid pressure Pₘᵢₙ), then the accumulator 136 may be regarded to be in the low charge or low-energy state. With the configuration of the present braking system 116, during such low-energy state, the controller 154 optimizes usage of the fluid or charge remnant in the accumulator 136. Specifically, the controller 154 triggers the brake valve 144 into routing as much pressurized fluid from the accumulator 136 into the brake actuators 120 until the brake actuators 120 are filled to the pre-determined threshold value of fluid pressure Pbaₘᵢₙ. Moreover, the controller 154 additionally configures the brake valve 144 to prevent any fluid from exiting the brake actuator 120 and entering the fluid sump 146. Hence, the controller 154 maintains the brake member 118 in the touch up position and causes a certain amount of brake drag F_{drag} to be experienced by the machine 100.

As disclosed earlier herein, the controller 154 may be additionally configured to determine an actuation and/or magnitude of actuation of the control module 148 based on the signal S2 from the actuation sensor 150. If the controller 154 determines that an attempt has been made to actuate the control module 148 from its non-actuated configuration after detection of abnormality, then the controller 154 may increase the fluid pressure within the brake actuator 120 beyond the pre-determined threshold value of fluid pressure Pbaₘᵢₙ such that the brake member 118 is in the braking position with the rotating member 114 and allows a full or substantial braking force to be applied on the rotating member 114. Therefore, in the event of an abnormality, the touch up position is effected immediately to induce brake drag F_{drag} in the wheels 112 of the machine 100, and thereafter, upon any attempt to actuate the control module 148 from the non-actuated configuration, the braking position may be effected to bring the machine 100 to a halt.

Various standardized and/or widely known rules and regulations governing the construction of accumulators require that the accumulator is large enough to hold a rated capacity of pressurized fluid. In some cases, the accumulators previously constructed for use with conventional braking systems were up to three or four times the volume of fluid required to deploy substantial or full braking of rotating members. However, with the configuration of the present braking system 116, it is envisioned to use a smaller size of the accumulator 136 since a smaller amount of fluid may be required after a larger part of the pressurized fluid is discharged by the accumulator 136 for the touch up position. Therefore, a physical size of the accumulator 136 can be significantly smaller as compared to the previously known accumulators. For example, with implementation of the present disclosure, a size of the accumulator required can be reduced to 50% of that traditionally employed. In another example, the size of the accumulator can be reduced by 60% of the size previously used. Such reduction in the size of the accumulator 136 can offset added manufacturing costs, material costs, labor, and/or time involved in the manufacture of the accumulator 136. In addition to the reduction in size of the accumulators 136, the accumulators 136 also comply with the various rules and regulations governing the construction of accumulators.

It should be noted that the steps 502 to 504 disclosed herein are illustrative and other alternatives can also be provided where one or more steps are added, one or more steps are removed, or one or more steps are provided in a different sequence without departing from the scope of the claims herein. Further, modifications to embodiments of the present disclosure described in the foregoing are possible without departing from the scope of the present disclosure as defined by the accompanying claims. Expressions such as “including”, “comprising”, “incorporating”, “consisting of”, “containing”, “having”, and the like, used to describe and claim the present disclosure, are intended to be construed in a non-exclusive manner, namely allowing for components or elements not explicitly described also to be present.

While aspects of the present disclosure have been particularly shown and described with reference to the embodiments above, it will be understood that various additional embodiments may be contemplated by the modification of the disclosed machine, systems and methods without departing from the spirit and scope of what is disclosed. Such embodiments should be understood to fall within the scope of the present disclosure as determined based upon the claims and any equivalents thereof.

We claim:

1. A braking system comprising:
a brake charge module configured to supply a pressurized fluid;
an accumulator configured to store the pressurized fluid therein;
a pressure sensor coupled to the accumulator and configured to generate a signal corresponding to a fluid pressure within the accumulator;
a brake actuator configured to receive the pressurized fluid from the accumulator and selectively actuate a brake member therein based on a fluid pressure inside the brake actuator;
a brake valve disposed between the brake actuator and the accumulator, the brake valve configured to regulate a flow of the pressurized fluid between the accumulator and the brake actuator; and
a controller communicably coupled to at least the pressure sensor and the brake valve, the controller configured to:
determine a low-energy state of the accumulator based on at least the signal from the pressure sensor; and
maintain the fluid pressure within the brake actuator above a pre-determined threshold value to retain the brake member at a touch up position with respect to a rotating member.

2. The braking system of claim 1, wherein the low-energy state of the braking system corresponds to the fluid pressure within the accumulator falling below a pre-defined minimum value.

3. The braking system of claim 1, wherein the brake actuator comprises:
a brake cylinder configured to receive the pressurized fluid from the accumulator;
a brake piston disposed within the brake cylinder and coupled to the brake member; and
a biasing member configured to bias the brake piston and the brake member away from the rotating member.

4. The braking system of claim 3, wherein the pre-determined threshold value of the fluid pressure is greater than a force of the biasing member.

5. The braking system of claim 1, wherein the braking system further comprises:
a control module operable by a user from a non-actuated configuration; and
an actuation sensor communicably coupled to the controller, wherein the actuation sensor is configured to generate a signal corresponding to an actuation of the control implement.

6. The braking system of claim 5, wherein the controller is further configured to:
determine an actuation of the control module based on at least the signal from the actuation sensor; and
increase the fluid pressure within the brake actuator to move the brake member to a braking position with respect to the rotating member.

7. The braking system of claim 1, wherein the brake valve is a solenoid-actuated valve.

8. The braking system of claim 1, wherein the brake charge module comprises a pump configured to pressurize the fluid.

9. The braking system of claim 1, wherein the braking system further comprises a control valve disposed between the brake charge module and the accumulator, the control valve configured to regulate a flow of the pressurized fluid from the brake charge module to the accumulator.

10. A machine comprising:
at least one rotating member therein; and
a braking system operatively coupled to the at least one rotating member, wherein the braking system comprises:
a brake charge module configured to supply a pressurized fluid;
an accumulator configured to store the pressurized fluid therein;
a pressure sensor coupled to the accumulator and configured to generate a signal corresponding to a fluid pressure within the accumulator;
a brake actuator configured to receive the pressurized fluid from the accumulator and selectively actuate a brake member therein based on a fluid pressure inside the brake actuator;
a brake valve disposed between the brake actuator and the accumulator, the brake valve configured to regulate a flow of the pressurized fluid between the accumulator and the brake actuator; and
a controller communicably coupled to at least the pressure sensor and the brake valve, the controller configured to:
determine a low-energy state of the accumulator based on at least the signal from the pressure sensor; and
maintain the fluid pressure within the brake actuator above a pre-determined threshold value to retain the brake member at a touch up position with respect to the at least one rotating member.

11. The machine of claim 10, wherein the low-energy state of the braking system corresponds to the fluid pressure within the accumulator falling below a pre-defined minimum value.

12. The machine of claim 10, wherein the brake actuator comprises:
a brake cylinder configured to receive the pressurized fluid from the accumulator;
a brake piston disposed within the brake cylinder and coupled to the brake member; and
a biasing member configured to bias the brake piston and the brake member away from the rotating member.

13. The machine of claim 12, wherein the pre-determined threshold value of the fluid pressure is greater than a force of the biasing member.

14. The machine of claim 10, wherein the braking system further comprises:
a control module operable by a user from a non-actuated configuration; and
an actuation sensor communicably coupled to the controller, wherein the actuation sensor is configured to generate a signal corresponding to an actuation of the control implement.

15. The machine of claim 14, wherein the controller is further configured to:
determine an actuation of the control module based on at least the signal from the actuation sensor; and
increase the fluid pressure within the brake actuator to move the brake member to a braking position with respect to the rotating member.

16. A method of controlling a braking system, the method comprising:
determining, by a controller, low-energy state of an accumulator of the braking system based on at least a fluid pressure within the accumulator; and
maintaining a fluid pressure of a brake actuator above a pre-determined threshold value such that a brake member therein is maintained in a touch-up position with respect to a rotating member.

17. The method of claim 16, wherein the low-energy state of the braking system corresponds to the fluid pressure within the accumulator falling below a pre-defined minimum value.

18. The method of claim 16, wherein maintaining the fluid pressure of the brake actuator above the pre-determined threshold value includes increasing the fluid pressure in the brake actuator to a value above the pre-determined threshold value.

19. The method of claim 16, wherein the method includes biasing the brake member away from the rotating member with a biasing force.

20. The method of claim 19, wherein the pre-determined threshold value of the fluid pressure is greater than the biasing force.
